(19) United States
(12) Patent Application Publication
(10) Pub. No.: US 2013/0160617 A1
(43) Pub. Date: Jun. 27, 2013

(54) HAND TOOL WITH AN ELBOW STRUCTURE

(71) Applicant: KABO TOOL COMPANY, Taichung City (TW)

(72) Inventor: Chih-Ching HSIEH, Taichung City (TW)

(73) Assignee: KABO TOOL COMPANY, Taichung City (TW)

(21) Appl. No.: 13/772,743

(22) Filed: Feb. 21, 2013

Related U.S. Application Data
(63) Continuation-in-part of application No. 12/128,608, filed on May 28, 2008, now abandoned.

(51) Int. Cl. B25B 23/142; B25B 23/00; B25B 23/16

(52) U.S. Cl. CPC B25B 23/1427; B25B 23/16; B25B 23/0007
USPC 81/467; 81/177.85; 81/177.2

(57) ABSTRACT

A hand tool includes a handle and an elbow structure. The handle has a grasp portion and a rod portion connecting collinearly. The elbow structure has a first section and a second section, wherein the first section connects with the handle collinearly, and the second section connected to the first section slantwise at an acute angle. A complementary angle to the acute angle is defined thereby. The hand tool defines an operative length, which is along the first axis of the first section from a bottom end of the grasp portion of the handle to a top end of the first section of the elbow structure. The operative length going with the complementary angle offers the hand tool facile manipulation.

This application is a continuation-in-part of application Ser. No. 12/128,608, filed on May 28, 2008.

### FIELD OF THE INVENTION

The present invention relates to a hand tool, and more particularly to a hand tool with an elbow structure.

### BACKGROUND OF THE INVENTION

A first conventional hand tool is shown in FIG. 7. The first conventional hand tool includes a handle (1′), and a rod (2′) extending from the handle (1′) along an axis of the handle (1′). A function head (3′) extends from the rod (2′) along an axis of the rod (2′). A driving unit (4′) perpendicularly extends from the function head (3′) for driving a fastener (not shown), such as a socket or a nut.

If the first hand tool is necessary to apply for a fastener in sunken place or a depression. It is obviously the driving unit (4′) per se is not long enough to reach the fastener and not even capable of offering driving function. A driving unit (4′) to be longer or to distance from the function head (3′) is required thereby.

With reference to FIG. 8, the second conventional hand tool includes a handle (1″), a rod (2″) extending from the handle (1″) along an axis of the handle (1″), and a driving unit (3″) extending from the rod (2″). The driving unit (3″) is L-shaped and includes a first segment (31″) and a second segment (32″) perpendicularly connected to the first segment (31″). The first segment (31″) is longitudinally connected to the rod (2″), and a right angle α is formed between the first segment (31″) and second segment (32″).

In the second conventional hand tool, the second segment (32″) of the driving unit (3″) is set longer to approach the problem though, which the first conventional hand tool has met. However, the right angle a there constrains the manipulation of the second conventional hand tool operating only within an open area. Once it is needed to apply for a fastener in a sunken place, a short distance (d) between the handle (1″) and a block is inadequate and not reasonable for operation. The user's hand would easily collide with the block when operating the second conventional hand tool.

U.S. Pat. No. 7,500,418 discloses a torque setting lug wrench with an angle α of 110-130 degrees between the first section (110) and the second section (120), an included angle of 70-50 degrees between the first and second sections is formed. However, such arrangement does not put the wrench in a better condition for use.

The present invention has arisen to mitigate and/or obviate the disadvantages of the conventional hand tools.

### SUMMARY OF THE INVENTION

The main objective of the present invention is to provide a hand tool with an acute angle adequately. The acute angle going with a reasonable operative length of the hand tool provides facile and easy manipulation of the hand tool.

To achieve the objective, the hand tool in accordance with the present invention comprises a handle and an elbow structure. The handle has a grasp portion and a rod portion, and the rod portion extends from the grasp portion in a collinear manner. The elbow structure has a first section and a second section. The first section extends from the rod portion in a collinear manner; the second section fixedly connects the first section in a slantwise manner at an acute angle, which is defined from a first axis of the first section to a second axis of the second section. The second section has a driving portion formed at a distal end thereof. For meeting the requirements of facile and easy manipulation of the hand tool, the hand tool defines a complementary angle, which is summed up to 90 degrees with the acute angle; the hand tool has an operative length, which is predetermined along the first axis of the first section from a bottom end of the grasp portion of the handle to a top end of the first section of the elbow structure. The sine of the complementary angle gives a fixed ratio, which is of a fixed distance opposite to the complementary angle toward the operative length. The acute angle is greater than 70 degrees and less than 80 degrees. Therefore, the complementary angle to the acute angle, going with the operative length offers the hand tool the fixed distance for facile manipulation.

To achieve the objective, the hand tool in accordance with the present invention comprises a handle and an elbow structure. The handle has a grasp portion and a rod portion, and the rod portion extends from the grasp portion in a collinear manner. The elbow structure has a first section and a second section. The first section extends from the rod portion in a collinear manner; the second section fixedly connects the first section in a slantwise manner at an acute angle, which is defined from a first axis of the first section to a second axis of the second section. The second section has a driving portion formed at a distal end thereof. For meeting the requirements of facile and easy manipulation of the hand tool, the acute angle is preferably greater than 70 degrees and less than 80 degrees. The hand tool has an operative length, which is predetermined along the first axis of the first section from a bottom end of the grasp portion of the handle to a top end of the first section of the elbow structure. The second section of the elbow structure defines an extension length. A ratio of the extension length to the operative length preferably ranges from 1:5 to 1:7. Therefore, the acute angle going with the ratio offers the hand tool facile manipulation.

Further benefits and advantages of the present invention will become apparent after a careful reading of the detailed description with appropriate reference to the accompanying drawings.

### BRIEF DESCRIPTION OF THE DRAWINGS

FIG. 1 is a side view of a hand tool with an elbow structure of a first preferred embodiment in accordance with the present invention;

FIG. 2 is a front view of the hand tool in accordance with the present invention;

FIG. 3 is a perspective view of the hand tool with an elbow structure in accordance with the present invention;

FIG. 4 is an operational view of the hand tool in FIG. 3;

FIG. 5 is a side view of a second preferred embodiment of the elbow structure of the hand tool in accordance with the present invention;

FIG. 6 is an operational view of the elbow structure in FIG. 5;

FIG. 7 is a perspective view of a first conventional hand tool in accordance with the prior art; and

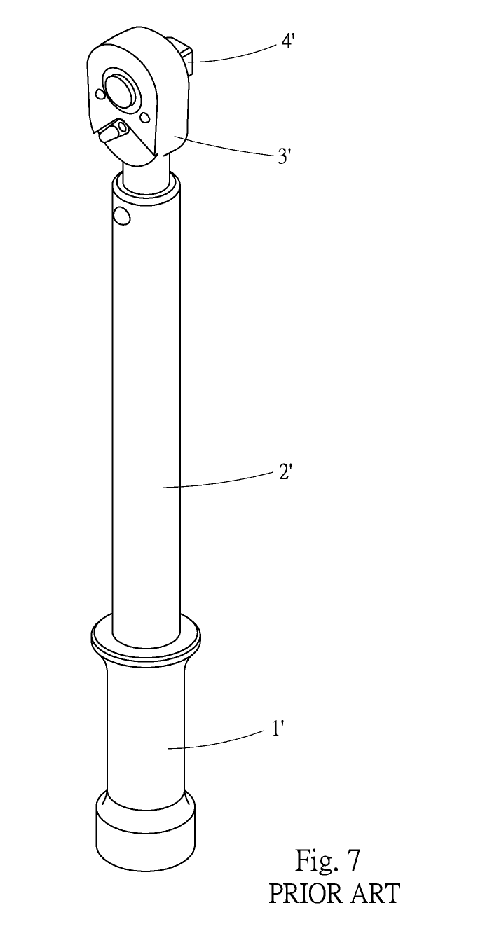

FIG. 8 is an operational view of a second conventional hand tool in accordance with the prior art.

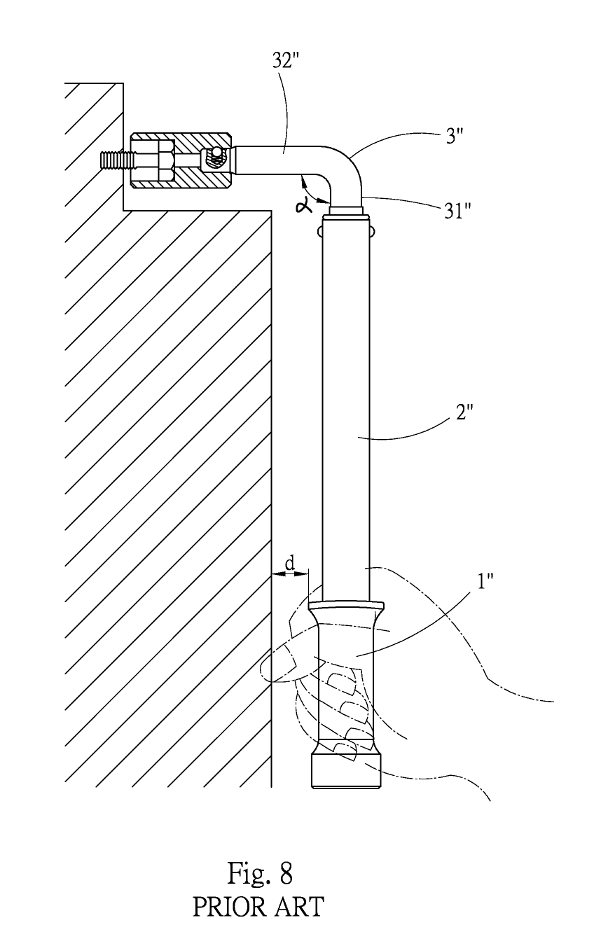

### DETAILED DESCRIPTION OF THE PREFERRED EMBODIMENTS

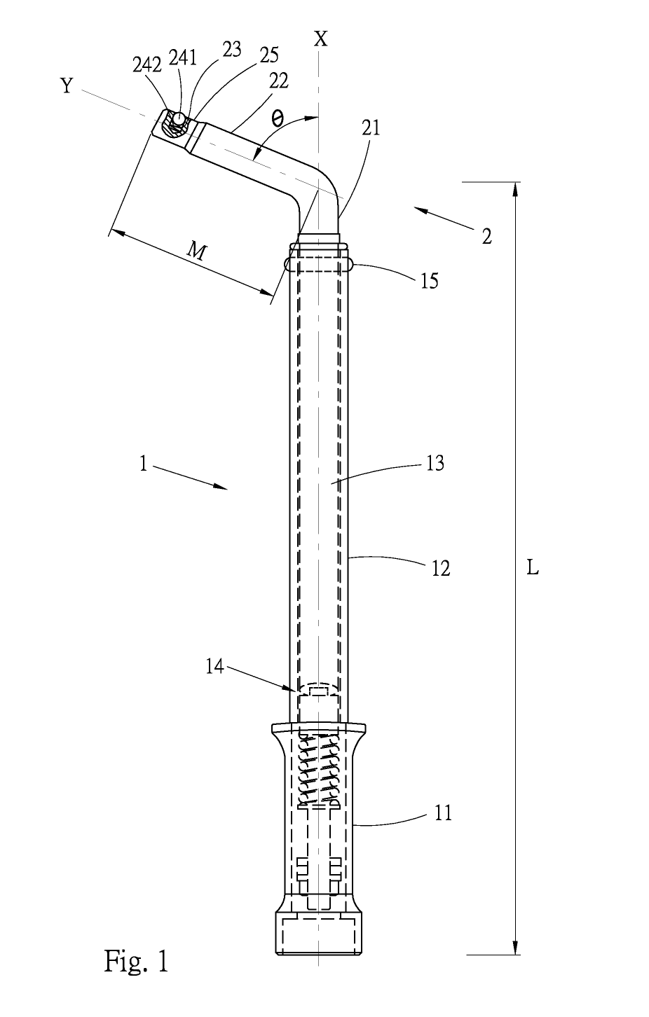

Referring to the drawings of FIGS. 1 to 4, a hand tool in accordance with a preferred embodiment of the present invention comprises a handle (1) and an elbow structure (2). The handle (1) includes a grasp portion (11) and a rod portion (12). The rod portion (12) extends from the grasp portion (11) in a collinear manner. The elbow structure (2) includes a first section (21) and a second section (22). The first section (21) extends from the rod portion (12) of the handle (1) in a collinear manner, so that the first section (21), the rod portion (12) and the grasp portion (11) defines a first axis (X) together. The second section (22) defines a second axis (Y). The second section (22) is fixedly connected to the first section (21) in a slantwise manner at an acute angle θ, and the acute angle θ is defined from the first axis (X) of the first section (21) to the second axis (Y) of the second section (22). The hand tool further defines an operative length (L), which is predetermined along the first axis (X) of the first section (21) from a bottom end of the grasp portion (11) of the handle (1) to a top end of the first section (21) of the elbow structure (2).

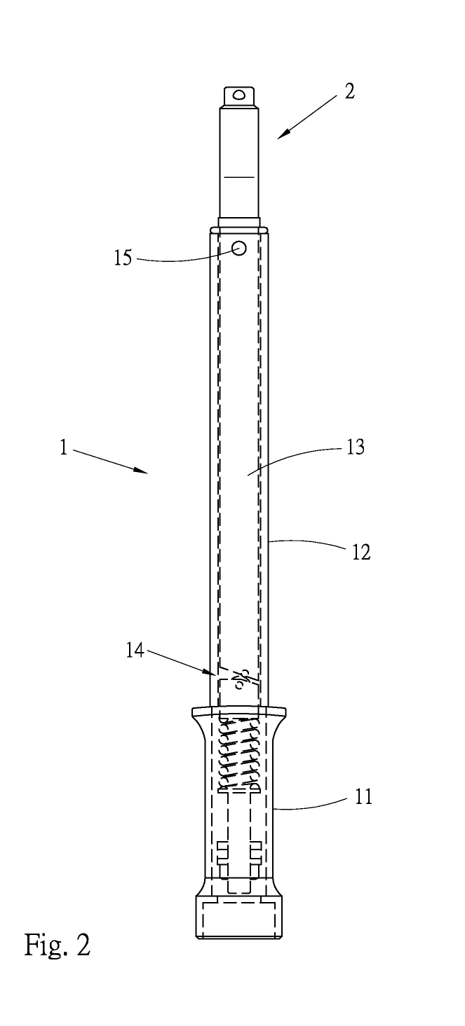

The hand tool in the embodiment is a torque wrench. Please refer to FIG. 2, the grasp portion (11) and the rod portion (12) are hollow. A torque detective mechanism (14) is received in the rod portion (12) for a warning effect when a torque of the hand tool is overloaded. The torque detective mechanism (14) has a spindle (13), which extends through the rod portion (12) and longitudinally connected to the first section (21) of the elbow structure (2) for measuring the torque of the hand tool from the elbow structure. The spindle (13) is pivoted to the rod portion (12) via a pin (15).

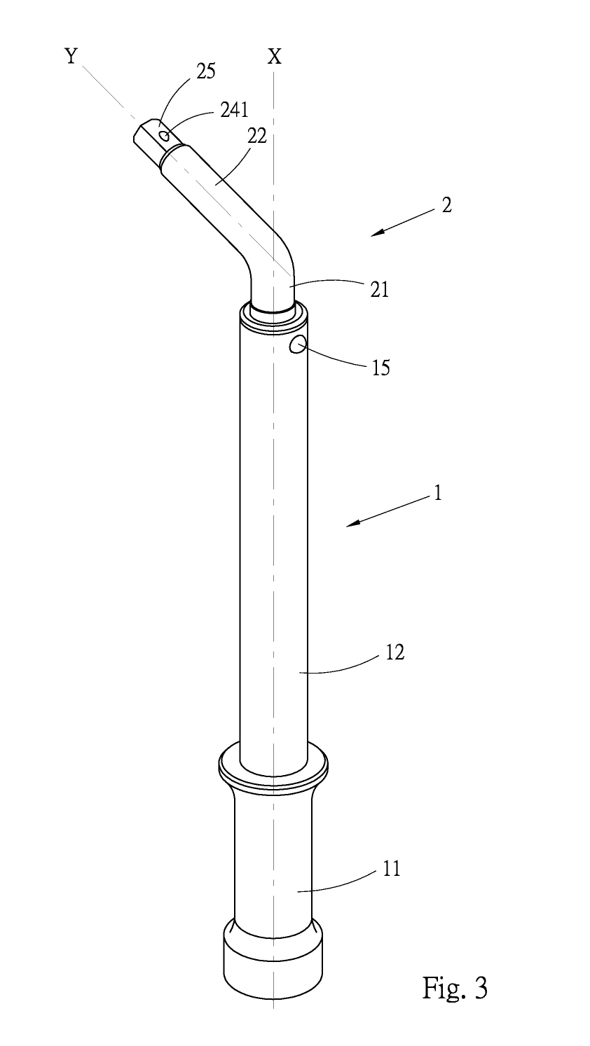

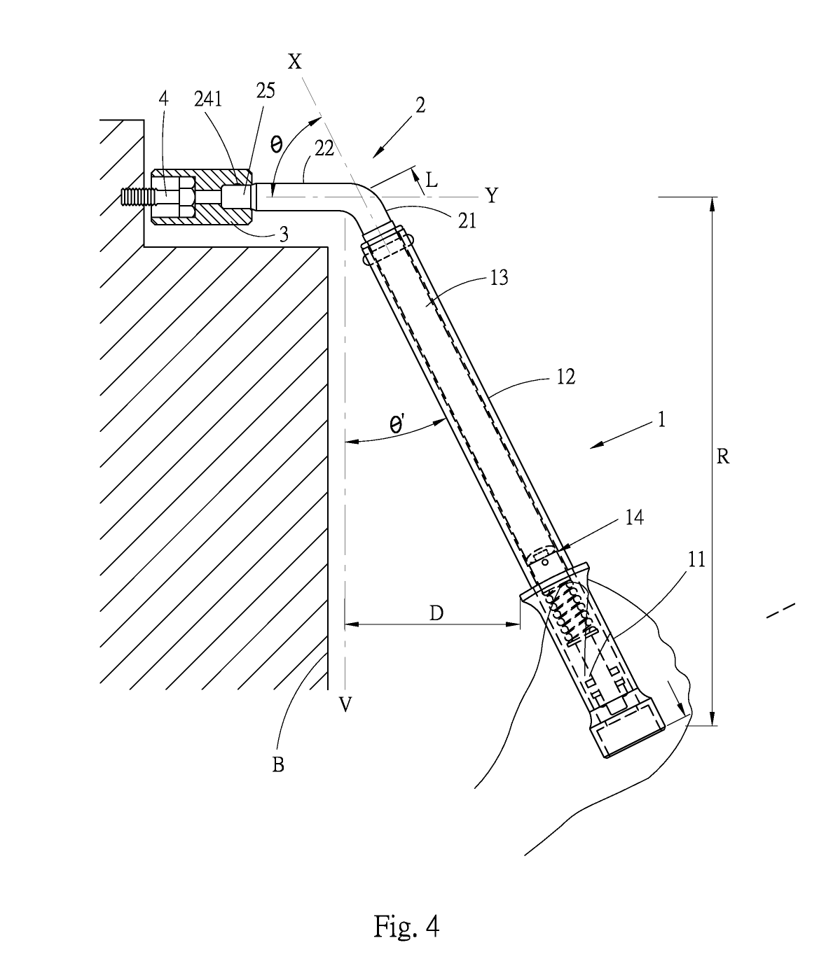

The elbow structure (2) further has a driving portion (25), a hole (23), a ball (241), and a compression spring (242). The driving portion (25) is formed at a distal end of the elbow structure (2). The hole (23) is formed at the driving portion (25); the ball (241) is set in the hole (23); and the compression spring (242) is disposed in the hole (23) and abutting against the ball (241). The ball (241) could be exposed out of the driving portion (25) and hidden inside the driving portion (25) in an alternative manner. For the driving portion (25) further adapting for a socket (3), illustrated in FIG. 4, the driving portion (25) is polygon-like, as shown in FIG. 3, for being sheathed by the socket (3), in FIG. 4. Due to the ball (241) forced by the compression spring (242), the ball (241) is kept exposure out of the driving portion (25), so that it is capable of engaging with the socket (3) when the driving portion (25) is sheathed by one.

As illustrated in FIG. 4, the hand tool in accordance with the present invention adapted for the socket (3) is to drive a screw nut (4) in the sunken place. While the second section (22) is slantwise relative to the first section (21) at the acute angle θ, a complementary angle θ′ is formed thereby. The acute angle θ and the complementary angle θ′ are summed up to 90 degrees, and the complementary angle θ′ is measured from the first axis (X) of the first section (21) to a vertical line (V), which is virtual and imaginary. Under the acute angle θ, the sine of the complementary angle θ′, designated as sine (θ′), gives a fixed ratio of a fixed distance opposite to the complementary angle θ′ toward the operative length (L). The fixed distance is given as sine (θ′)*L thereby. The complementary angle θ′ going with the operative length (L) guarantees sufficient space, which is spanned by the fixed distance, for the user to operate the grasp portion (11) of the handle (1). It obviously provides an adequate distance (D) between the grasp portion (11) and the block (B), and that makes abundant space for the manual operation of the grasp portion (11) much reasonable, easy and facile. The predetermined operative length (L) per se guarantees a sufficient lever-arm distance (R), which equals to cosine (θ′)*L, for the screw nut (4), and that makes the manual operation of the hand tool in the present invention much effort-saving. With the adequate distance (D) and the lever-arm distance (R), the hand tool in the present invention is not only free from obstacles while in use but also provides enough force for wrenching facilely and easily.

For effective operation, the acute angle θ is greater than 70 degrees and less than 80 degrees. While the acute angle θ is greater than 70 degrees and less than 80 degrees, the complementary angle θ′ keeps greater than 10 degrees and less than 20 degrees. The adequate distance (D) would be found and good for the user operating the grasp portion (11) of the hand tool. For further effective operation, the operative length (L) of the hand tool in the present invention preferably ranges from 40 centimeters to 50 centimeters. Under the acute angle θ and the operative length (L), the adequate distance (D), illustrated in FIG. 4, is assured by the fixed distance, sine (θ′)*L, would be much sure, no matter in the open area or the sunken place, to guarantee much easy and facile manipulation of the grasp portion (11) of the hand tool.

Under the arrangement of the present invention, an effective lever-arm (R) and an effective torque of the hand tool are enhanced.

As illustrated in FIG. 1, an extension length (M) of the second section (22) along the second axis (Y) is defined. A ratio of the extension length (M) of the second section (22) to the operative length (L) of the hand tool is obtained thereby. When the ratio of the extension length (M) of the second section (22) to the operative length (L) of the hand tool ranges from 1:5 to 1:7, it gives user further easy manipulation and ensures less impediments and more possibilities for the hand tool in the present invention to meet various requests.

For further effective operation, the acute angle θ is greater than 70 degrees and less than 75 degrees, or the ratio of the extension length (M) of the second section (22) to the operative length (L) of the hand tool becomes more specific to be about 1:6. The specific range of the acute angle θ keeps the complementary angle θ′ larger and the fixed distance, sine (θ′)*L, longer, the manipulation for user is more spacious thereby.

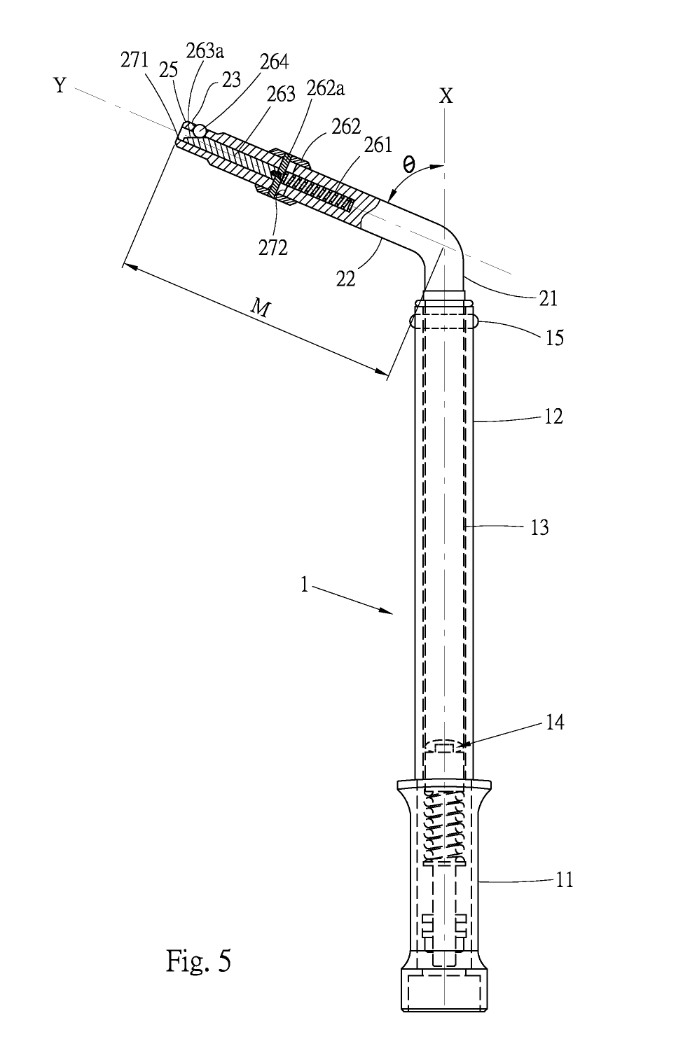

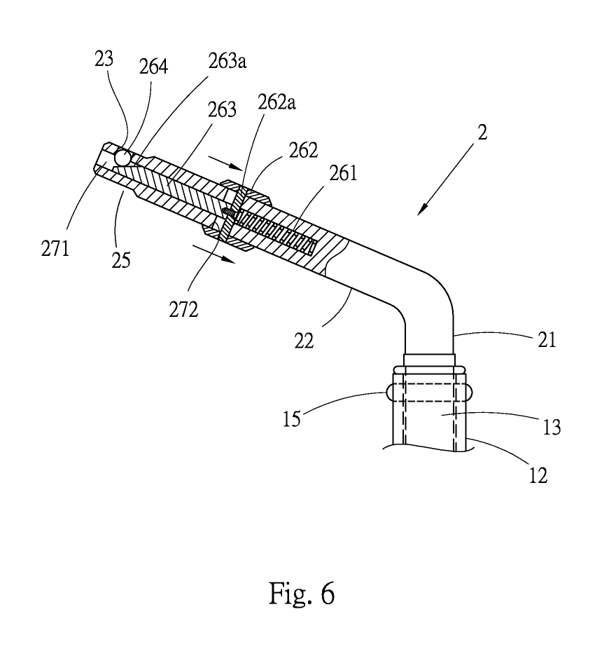

With reference to FIG. 5 and FIG. 6, a second preferred embodiment of the elbow structure (2) of the hand tool in the present invention is illustrated. The driving portion (25) of the second section (22) according to the second embodiment is also polygon-like, and the hole (23) is also formed at the driving portion (25). The second section (22) of the elbow structure (2) according to the second embodiment additionally defines an internal cavity (271) longitudinally along the second axis (Y) thereof in a collinear manner, and defines a through passage (272) penetrating the second section (22). The through passage (272) and the hole (23) communicate with the internal cavity (271). The hole (23) and the through passage (272) communicate with the internal cavity (271). The second section (22) of the elbow structure (2) according to the second embodiment includes a shaft (263), a compression spring (261), a switch member (262), and a ball (264). The switch member (262) sleeves externally on the second section (22), and the switch member (262) includes a conjunct portion (262a), which is arranged within the through passage (272) and is slidable longitudinally along the internal cavity (271). The switch member (262) moves forwards and backwards by the conjunct portion (262a) setting within the through passage (272) and sliding along the internal cavity (271). An end of the compression spring (261) and an end of the shaft (263) are reversely secured to the conjunct portion (262a) of the switch member (262). An opposite end of the compression spring (261) is secured in the internal cavity (271) so as to keep a restitution force. An opposite end of the shaft (263) defines an inclined face (263a) abutting against the ball (264), which is set in the hole (23). The ball (264) is exposed out of hole (23) of the second section (22), while the switch member (263) is at an engagement position; for the time being, the ball (264) stands on top of the inclined face (263a) of the shaft (263) and the switch member (263) stays forwards, illustrated in FIG. 5. Alternatively, the ball (264) is hidden in the hole (23), while the switch member (262) is at a release position; for the time being, the ball (264) stands at bottom of the inclined face (263a) of the shaft (263) and the switch member (263) is moved backwards, illustrated in FIG. 6.

The driving portion (25), with the ball (264) exposed, in the second embodiment is also capable of engaging with a fastener, such as a socket (as shown in FIG. 4) or a nut. The second section (22) of the elbow structure (2) in the second embodiment functions a nice and quick release mechanism, in order to change the fastener quicker and better. The hand tool in the second embodiment also keeps the configuration of the operative length (L) per se, and the acute angle θ, (or even the ratio of the extension length (M) to the operative length (L)) in a preferable manner as well as in the first embodiment.

Although the invention has been explained in relation to its preferred embodiment, it is to be understood that many other possible modifications and variations can be made without departing from the spirit and scope of the invention as hereinafter claimed.

What is claimed is:

1. A hand tool with an elbow structure comprising:
a handle having a grasp portion and a rod portion; the rod portion extending from the grasp portion in a collinear manner; and
an elbow structure having a first section and a second section; the first section extending from the rod portion in a collinear manner; the second section fixedly connecting the first section in a slantwise manner at an acute angle, which is defined from a first axis of the first section to a second axis of the second section; the second section having a driving portion formed at a distal end thereof and a ball set at the driving portion; the driving portion being polygon-like, and the ball being exposed out of the driving portion and hidden inside the driving portion in an alternative manner;
wherein the hand tool defines a complementary angle, which is summed up to 90 degrees with the acute angle; the hand tool has an operative length, which is along the first axis of the first section from a bottom end of the grasp portion of the handle to a top end of the first section of the elbow structure; the sine of the complementary angle gives a fixed ratio, which is of a fixed distance opposite to the complementary angle toward the operative length; the acute angle is greater than 70 degrees and less than 80 degrees; whereby the operative length going with the complementary angle offers the hand tool the fixed distance, which is spacious enough, for facile manipulation;
wherein the second section of the elbow structure defines an extension length, and a ratio of the extension length to the operative length ranges from 1:5 to 1:7.

2. The hand tool as claimed in claim 1, wherein the operative length ranges from 40 centimeters to 50 centimeters.

3. The hand tool as claimed in claim 1, wherein the acute angle is greater than 70 degrees and less than 75 degrees.

4. The hand tool as claimed in claim 2, wherein the acute angle is greater than 70 degrees and less than 75 degrees.

5. The hand tool as claimed in claim 1, wherein the ratio of the extension length to the operative length is about 1:6.

6. The hand tool as claimed in claim 2, wherein the ratio of the extension length to the operative length is about 1:6.

7. The hand tool as claimed in claim 1, wherein the second section of the elbow structure further includes a shaft, a compression spring and a switch member; an internal cavity is formed in the second section in a collinear manner and communicated by the hole; a through passage penetrates the second section and communicates with the internal cavity; the compression spring and the shaft are received in the internal cavity of the second section, the switch member sleeves externally on the second section, and the switch member includes a conjunct portion, which is arranged within the through passage and is slidable longitudinally along the internal cavity; the ball is set in the hole; an end of the compression spring and an end of the shaft are reversely secured to the conjunct portion of the switch member; an opposite end of the compression spring is secured in the internal cavity and an opposite end of the shaft abuts against the ball; the ball is exposed out of hole of the second section while the switch member is at an engagement position, and alternatively the ball is hidden in the hole while the switch member is at a release position.

8. The hand tool as claimed in claim 2, wherein the second section of the elbow structure further includes a shaft, a compression spring and a switch member; an internal cavity is formed in the second section in a collinear manner and communicated by the hole; a through passage penetrates the second section and communicates with the internal cavity; the compression spring and the shaft are received in the internal cavity of the second section, the switch member sleeves externally on the second section, and the switch member includes a conjunct portion, which is arranged within the through passage and is slidable longitudinally along the internal cavity; the ball is set in the hole; an end of the compression spring and an end of the shaft are reversely secured to the conjunct portion of the switch member; an opposite end of the compression spring is secured in the internal cavity and an opposite end of the shaft abuts against the ball; the ball is exposed out of hole of the second section while the switch member is at an engagement position, and alternatively the ball is hidden in the hole while the switch member is at a release position.

9. The hand tool as claimed in claim 1, wherein the rod portion of the handle is hollow; a torque detective mechanism is received in the rod portion, the torque detective mechanism has a spindle extending through the rod portion and longitudinally connected to the first section of the elbow structure, the spindle is pivoted to the rod portion.

10. The hand tool as claimed in claim 2, wherein the rod portion of the handle is hollow; a torque detective mechanism is received in the rod portion, the torque detective mechanism has a spindle extending through the rod portion and longitudinally connected to the first section of the elbow structure, the spindle is pivoted to the rod portion.

11. A hand tool with an elbow structure comprising:
a handle having a grasp portion and a rod portion; the rod portion extending from the grasp portion in a collinear manner; and
an elbow structure having a first section and a second section; the first section extending from the rod portion in a collinear manner; the second section fixedly connecting the first section in a slantwise manner at an acute angle, which is defined from a first axis of the first section to a second axis of the second section; the second section having a driving portion formed at a distal end thereof and a ball set at the driving portion; the driving portion being polygon-like, and the ball being exposed out of the driving portion and hidden inside the driving portion in an alternative manner;
wherein the acute angle is greater than 70 degrees and less than 80 degrees; the hand tool has an operative length, which is predetermined along the first axis of the first section from a bottom end of the grasp portion of the handle to a top end of the first section of the elbow structure; the second section of the elbow structure defines an extension length, and a ratio of the extension length to the operative length ranges from 1:5 to 1:7.

12. The hand tool as claimed in claim 11, wherein the ratio of the extension length to the operative length is about 1:6.

13. The hand tool as claimed in claim 11, wherein the acute angle is greater than 70 degrees and less than 75 degrees.

14. The hand tool as claimed in claim 11, wherein the ratio of the extension length to the operative length is about 1:6, and the acute angle is greater than 70 degrees and less than 75 degrees.

15. The hand tool as claimed in claim 11, wherein the operative length ranges from 40 centimeters to 50 centimeters.

16. The hand tool as claimed in claim 12, wherein the operative length ranges from 40 centimeters to 50 centimeters.

17. The hand tool as claimed in claim 11, wherein the second section of the elbow structure further includes a shaft, a compression spring and a switch member; an internal cavity is formed in the second section in a collinear manner and communicated by the hole; a through passage penetrates the second section and communicates with the internal cavity; the compression spring and the shaft are received in the internal cavity of the second section, the switch member sleeves externally on the second section, and the switch member includes a conjunct portion, which is arranged within the through passage and is slidable longitudinally along the internal cavity; the ball is set in the hole; an end of the compression spring and an end of the shaft are reversely secured to the conjunct portion of the switch member; an opposite end of the compression spring is secured in the internal cavity and an opposite end of the shaft abuts against the ball; the ball is exposed out of hole of the second section while the switch member is at an engagement position, and alternatively the ball is hidden in the hole while the switch member is at a release position.

18. The hand tool as claimed in claim 15, wherein the second section of the elbow structure further includes a shaft, a compression spring and a switch member; an internal cavity is formed in the second section in a collinear manner and communicated by the hole; a through passage penetrates the second section and communicates with the internal cavity; the compression spring and the shaft are received in the internal cavity of the second section, the switch member sleeves externally on the second section, and the switch member includes a conjunct portion, which is arranged within the through passage and is slidable longitudinally along the internal cavity; the ball is set in the hole; an end of the compression spring and an end of the shaft are reversely secured to the conjunct portion of the switch member; an opposite end of the compression spring is secured in the internal cavity and an opposite end of the shaft abuts against the ball; the ball is exposed out of hole of the second section while the switch member is at an engagement position, and alternatively the ball is hidden in the hole while the switch member is at a release position.

19. The hand tool as claimed in claim 11, wherein the rod portion of the handle is hollow; a torque detective mechanism is received in the rod portion, the torque detective mechanism has a spindle extending through the rod portion and longitudinally connected to the first section of the elbow structure, the spindle is pivoted to the rod portion.
